(19) United States
(12) Patent Application Publication
(10) Pub. No.: US 2012/0226550 A1
(43) Pub. Date: Sep. 6, 2012

(54) METHOD, SERVER, AND COMPUTER-READABLE RECORDING MEDIUM FOR PROVIDING ADVERTISEMENT USING COLLECTION INFORMATION

(75) Inventor: Jung Hee Ryu, Seoul (KR)

(73) Assignee: OLAWORKS, INC., Seoul (KR)

(21) Appl. No.: 13/327,962

(22) Filed: Dec. 16, 2011

(30) Foreign Application Priority Data
Mar. 2, 2011 (KR) 10-2011-0018611

(51) Int. Cl. G06Q 30/02

(52) U.S. Cl. 705/14.52

(57) ABSTRACT

The present invention relates to a method for providing advertisement by using collection information. The method includes the steps of: allowing recognition reference information on an object from a vendor server to be received; allowing collection information to be acquired; allowing the object corresponding to the basic recognition information to be recognized by comparing between the basic recognition information included in the digital data in the collection information acquired from the user terminal and the recognition reference information received from the vendor server and allowing statistical collection information to be calculated by referring to the information on the recognized object and a user of the user terminal who remits the basic recognition information; and allowing advertising information on a peculiar object to be provided for a user terminal(s) included in a specific user group.

### CROSS-REFERENCE TO RELATED APPLICATION

This application claims priority to and incorporates herein by reference all disclosure in Korean Patent Application No. 10-2011-0018611 filed Mar. 2, 2011.

### FIELD OF THE INVENTION

The present invention relates to a method, a server and a computer-readable recording medium for providing an advertisement by using collection information; and more particularly, to the method, the server and the computer-readable recording medium for allowing a vendor to provide an advertisement which meets collection tendency of users and allowing a system operator to easily acquire recognition reference information on an external database required for recognizing an object by (i) recognizing the object corresponding to basic recognition information included in digital data in collection information collected from user terminals in comparison between the basic recognition information and the recognition reference information on the database received from a vendor's server, (ii) providing the vendor's server with calculated statistical collection information with reference to information on users of user terminals which transmit the basic recognition information and information on the recognized object, and (iii) providing advertising information on a peculiar object for a specific user group if the peculiar object and the specific user group are selected by the vendor.

### BACKGROUND OF THE INVENTION

Recently, due to the wide spread use of the Internet, it has been common to provide information converted to a digital form which was once offered in a form of printing such as books. Furthermore, since information converted into digital data may be shared in real time and transmitted among many users thanks to the spread of high-speed communication systems such as a 3G network and the Internet, such digital data has been more widely used compared to printing materials which relatively have demerits from the aspects of information sharing and transmission.

In particular, a technology for providing detailed information on an object existing in reality by using an image of the object taken in real time or other recognition information on the object acquired by a user terminal has been recently introduced.

Upon providing a variety of services including detailed information regarding numerous objects existing in reality as described above, it is actually difficult to effectively store an image taken or inputted by the user terminal or other recognition information therethrough. Besides, it is vexatious to systematically record and store only the information on objects with relatively high degrees of interest (or importance) differentially. Therefore, it is true that there is a certain level of limits to draw more active participation of consumers.

To provide information on an object a user wants and support the information to be systematically recorded and stored, a process for recognizing what the object is must be preceded by referring to recognition information such as an image, a barcode, a quick response (QR) code, a RFID tag, etc. of the object. But as for a service provider who has limited resources, since it is impossible in reality to acquire and manage the recognition information of all objects users want, i.e., all existing in the world, and particularly it is difficult to acquire recognition reference information on objects stored on an external database secretly managed by a particular vendor, such a service provider cannot provide a service for recognizing the object users want to get information on. Reversely, as for the vendor who sells an object, it is important to get more accurate and more useful information on which user is interested in which object in order to effectively perform marketing, inventory management, etc. However, in general, such information is retained by the service providers who provide information on objects users want to get and support such information to be systematically recorded and stored. Accordingly, a technology for allowing the service providers and the vendors to enter into close cooperation with each other to create a leverage effect is required.

### SUMMARY OF THE INVENTION

It is, therefore, an object of the present invention to solve all the problems mentioned above.

It is another object of the present invention to allow a vendor to provide an advertisement which meets collection tendency of users and allowing a system operator to easily acquire recognition reference information on an external database required for recognizing an object by (i) recognizing the object corresponding to basic recognition information included in digital data in collection information collected from user terminals in comparison between the basic recognition information and the recognition reference information on the database received from a vendor's server, (ii) providing the vendor's server with calculated statistical collection information with reference to information on users of user terminals which transmit the basic recognition information and information on the recognized object, and (iii) providing advertising information on a peculiar object for a specific user group if the peculiar object and the specific user group are selected by the vendor.

In accordance with one aspect of the present invention, there is provided a method for providing advertisement by using collection information, including the steps of: (a) allowing recognition reference information on an object sold or to be sold in relation to a vendor from a vendor server to be received by a recognition reference information collecting part; (b) allowing collection information, including digital data created by taking basic recognition information of the object with a user terminal or by acquiring the basic recognition information through a short distance communication, to be acquired by a collection information collecting part; (c) allowing the object corresponding to the basic recognition information to be recognized by a statistical collection information calculating part by comparing between the basic recognition information included in the digital data in the collection information acquired from the user terminal and the recognition reference information received from the vendor server and allowing statistical collection information to be calculated by the statistical collection information calculating part by referring to the information on the recognized object and a user of the user terminal who remits the basic recognition information; and (d) allowing advertising information on a peculiar object to be provided for a user terminal(s) included in a specific user group by an advertising information delivering part, if the vendor inputs information on selecting the peculiar object and the specific user group by referring to the statistical collection information which is given to the vendor server; wherein the collection is a process for acquiring the basic recognition information of the peculiar object the user intends to collect by using his or her user terminal and storing at least a piece of information on an identity of the peculiar object recognized by the acquired basic recognition information, a place where, and a time when, the basic recognition information thereof is acquired, a comment thereof and an image thereof; and wherein the basic recognition information is recognition information which is a clue for recognizing the identity of the object and wherein the recognition reference information is recognition information to be compared with the basic recognition information to recognize the identity of the object.

In accordance with another aspect of the present invention, there is provided a server for providing advertisement by using collection information, including: a recognition reference information collecting part for receiving recognition reference information on an object sold or to be sold in relation to a vendor from the vendor server; a collection information collecting part for collecting collection information including digital data created by taking basic recognition information of the object with a user terminal or by acquiring the basic recognition information through a short distance communication; a statistical collection information calculating part for recognizing the object corresponding to the basic recognition information by comparing between the basic recognition information included in the digital data in the collection information acquired from the user terminal and recognition reference information received from the vendor's server and calculating statistical collection information by referring to the information on the recognized object and a user of the user terminal who remits the basic recognition information; and an advertising information delivering part for providing advertising information on a peculiar object for a user terminals included in a specific user group, if the vendor inputs information on selecting the peculiar object and the specific user group by referring to the statistical collection information which is given to the vendor server; wherein the collection is a process for acquiring the basic recognition information of the peculiar object the user intends to collect by using his or her user terminal and storing at least a piece of information on an identity of the peculiar object recognized by the acquired basic recognition information, a place where, and a time when, the basic recognition information thereof is acquired, a comment thereof and an image thereof; and wherein the basic recognition information is recognition information which is a clue for recognizing the identity of the object and wherein the recognition reference information is recognition information to be compared with the basic recognition information to recognize the identity of the object.

### BRIEF DESCRIPTION OF THE DRAWINGS

The above and other objects and features of the present invention will become apparent from the following description of preferred embodiments given in conjunction with the accompanying drawings, in which:

FIG. 1 is a diagram exemplarily representing a configuration of an entire system to provide an advertisement by using collection information in accordance with an example embodiment of the present invention.

FIG. 2 is a drawing exemplarily illustrating a configuration of a user terminal 100 to support a collection of an object to be performed through a camera module or a short distance communication module of the terminal 100 in accordance with an example embodiment of the present invention.

FIG. 3 is a drawing showing an example of a collection page including information on an auto comment and information on an image of the object in accordance with an example embodiment of the present invention.

FIG. 4 is a diagram exemplarily representing a configuration of an advertisement providing server 200 for providing advertisement by using the collection information in accordance with an example embodiment of the present invention.

FIG. 5 is a drawing expressing an example of recognizing an identity of the object by comparing between basic recognition information and recognition reference information in accordance with an example embodiment of the present invention.

### DETAILED DESCRIPTION OF THE PREFERRED EMBODIMENTS

The detailed description of the present invention illustrates particular embodiments in which the present invention can be performed with reference to the attached drawings.

In the following detailed description, reference is made to the accompanying drawings that show, by way of illustration, particular embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The configurations of the present invention for accomplishing the objects of the present invention are as follows:

Herein, a “collection” is a so-called act of collecting an object in which a user is interested in a digital way and more specifically it may be defined as a process for acquiring basic recognition information (such as a taken image, a tag for a short distance communication or the like) of an object intended to be collected by using a user terminal and transmitting the acquired basic recognition information to a server which performs other subsequent functions (including functions of recognizing the object, creating and storing a collection page, calculating statistical collection information, etc.). For example, an act of a user to take a cover of a book by using the user's terminal and transmitting the taken image to the server to allow information on the book to be collected may fall under the collection with respect to the book.

Furthermore, the “collection” also may indicate not only the above-described process of transmitting the acquired basic recognition information to the server by using the user terminal but also processes of recognizing the object from the basic recognition information and creating and storing a page (so-called the collection page) by combining digital images, including information on an identity of the recognized object (such as a type, a characteristic, etc. thereof), a time when, and a place where, the basic recognition information thereof is acquired, a comment thereof, an image corresponding thereto, etc.

In addition, the “basic recognition information” with respect to the object herein means recognition information which becomes a clue for recognizing the object and more particularly, the recognition information actually acquirable by a terminal of a user who intends to collect the object. For instance, an image of an object taken by the user terminal, a name thereof, other recognition codes, a barcode, a quick response (QR) code, information on a radio-frequency identification (RFID) tag and information on a near field communication (NFC) tag acquired by a short distance communication module (non-illustrated) included in the user terminal, information on a location of the object acquired by a location recognition module include in the user terminal and the like may correspond to the basic recognition information.

In addition, the “recognition reference information” with respect to the object herein means information to be compared with the basic recognition information in order to recognize what the object corresponding to the basic recognition information acquired by the user terminal is and particularly recognition information created or managed by a vendor who produces or sells the object. For example, an image of the object itself, etc. managed by the vendor, a name thereof, other recognition codes, a barcode, a QR code, an RFID tag, an NFC tag, information on a location where the vendor places the object, etc. may correspond to the recognition reference information.

Furthermore, “short distance communications” herein as all available wireless communication technologies for acquiring the basic recognition information having been granted to the object must be understood as a concept of a widest meaning which includes RFID, NFC, etc.

### Configuration of Entire System

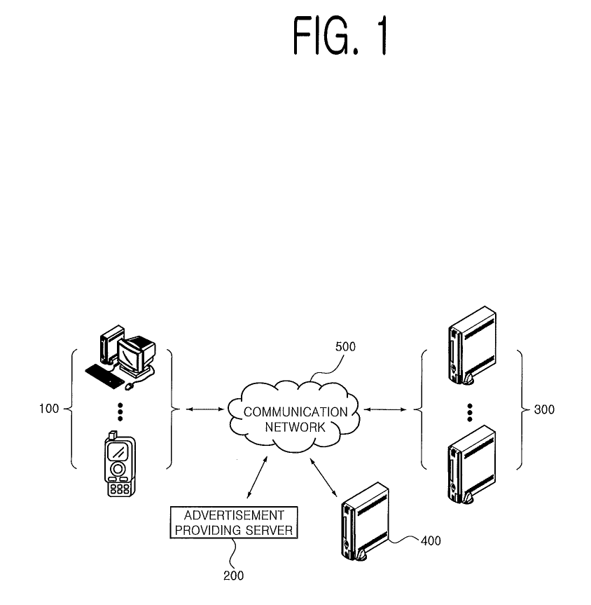

FIG. 1 briefly presents a configuration of an entire system for providing advertisement by using collection information in accordance with an example embodiment of the present invention.

As illustrated in FIG. 1, the entire system in accordance with an example embodiment of the present invention may include a user terminal 100, an advertisement providing server 200, a vendor server 300, a general web server 400, and a communication network 500. Herein, the vendor server 300 will be treated as a concept of including the vendor terminal.

First, the communication network 500 may be configured, regardless of wired or wireless, in a variety of networks, including a local area network (LAN), a metropolitan area network (MAN), a wide area network (WAN), etc.

In accordance with an example embodiment of the present invention, the user terminal 100 may be a digital device which includes a function of allowing the user to access to, and then communicate with, the advertisement providing server 200 or the web server 400 through the communication network 500. Herein, the digital device, such as a personal computer (e.g., desktop, laptop, etc.), a workstation, a PDA, a web pad, a cellular phone, a smart phone, a tablet PC, etc. which has a memory means and a micro processor with a calculation ability, may be adopted as the user terminal 100 in accordance with the present invention. An internal configuration of the user terminal 100 will be explained later.

Next, the advertisement providing server 200 in accordance with an example embodiment of the present invention may perform a function of recognizing an object corresponding to basic recognition information by comparing between the basic recognition information included in a digital data in collection information collected from the user terminal 100 and recognition reference information received from the vendor server 300, calculating, and providing the vendor server 300 with, statistical collection information by referring to information on the user of the user terminal 100 which transmits the basic recognition information and information on the recognized object, and providing advertising information on a peculiar object for the user terminal 100 included in a specific user group if the peculiar object and the specific user group are selected by the vendor server 300. Below will be a detailed explanation on an internal configuration of the advertisement providing server 200.

Next, the vendor server 300 in accordance with an example embodiment of the present invention may be a server which includes a function of allowing the vendor to access to, and then communicate with, the advertisement providing server 200. Herein, the digital device, such as a personal computer (e.g., desktop, laptop, etc.), a workstation, a PDA, a web pad, a cellular phone, a smart phone, a tablet PC, etc. which has a memory means and a micro processor with a calculation ability, may be adopted as the vendor server 300 or its configuration component in accordance with the present invention. More specifically, the vendor server 300 in accordance with an example embodiment of the present invention may perform a function of transmitting the recognition reference information created and managed for the object manufactured and sold by the vendor to the advertisement providing server 200 and receiving statistical information on the collection performed by the user from the advertisement providing server 200 and also may conduct a function of allowing the vendor to select the peculiar object and the specific user group which are the targets of advertisement by referring to the statistical information and then transmitting information on the selected peculiar object and the selected specific user group to the advertisement providing server 200 (Of course, the automatic selection of the specific user group with a highest statistical value may be included in various example embodiments). The vendor server 300 may be a server of the vendor for operating a website to provide products or services as well.

Moreover, the general web server 400 in accordance with an example embodiment of the present invention may communicate with the advertisement providing server 200 and/or the user terminal 100 through the communication network 500. For instance, the web server 400 may be a server for operating an internet search portal and the web server 400, at the time, may allow a user to search detailed info elation on the object that the user intends to collect and browse the search result by including a web content search engine (non-illustrated) therein. The detailed information provided as the search result may include various kinds of information on a price, a location, news, knowledge, a community, a website, etc. of the object.

### Configuration of User Terminal

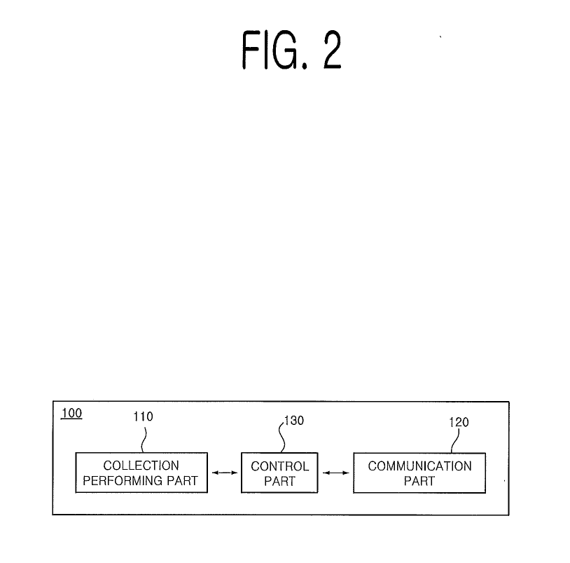

FIG. 2 exemplarily represents a configuration of the user terminal 100 to support performance of a collection of an object through a camera module or a short distance communication module thereof.

As illustrated in FIG. 2, the user terminal 100 in accordance with an example embodiment of the present invention may include a collection performing part 110, a communication part 120 and a control part 130. In accordance with an example embodiment of the present invention, at least some of the collection performing part 110, the communication part 120 and the control part 130 may be program modules communicating with the user terminal 100. The program modules may be included in the user terminal 100 in a faun of an operating system, an application program module and other program modules and may also be stored on several memory devices physically. Furthermore, the program modules may be stored on remote memory devices communicable to the user terminal 100. The program modules may include but not be subject to a routine, a subroutine, a program, an object, a component; and a data structure for executing a specific operation or a type of specific abstract data that will be described in accordance with the present invention.

First, the collection performing part 110 in accordance with an example embodiment of the present invention may perform a function of acquiring a taken image or information on a tag for a short distance communication as the basic recognition information which is used for a basis of object recognition to be explained later and transmitting such information to the advertisement providing server 200 which performs subsequent functions of recognizing an object, calculating statistical collection information, etc.

More precisely, the collection performing part 110 in accordance with an example embodiment of the present invention may perform a function of receiving a landscape around the user who carries the user terminal 100 in a state of preview in real time by using a camera module (non-illustrated) embedded in the user terminal 100. In addition, the collection performing part 110 in accordance with an example embodiment of the present invention may conduct a function of acquiring information on a tag for a short distance communication including information on an RFID tag, an NFC tag, etc. of the object by using a short distance communication module (non-illustrated) embedded in the user terminal 100.

Additionally, the collection performing part 110 in accordance with an example embodiment of the present invention may conduct a function of creating a collection page including information on a phrase or a sentence (so-called an auto comment) grammatically combined in a user's language by using the basic recognition information and at least one of a place where, and a time when, the basic recognition information is acquired, information on an image of an object which is a subject of the collection, etc. and, if the request for registering the created collection page is inputted, allowing the collection page to be transmitted to the advertisement providing server 200.

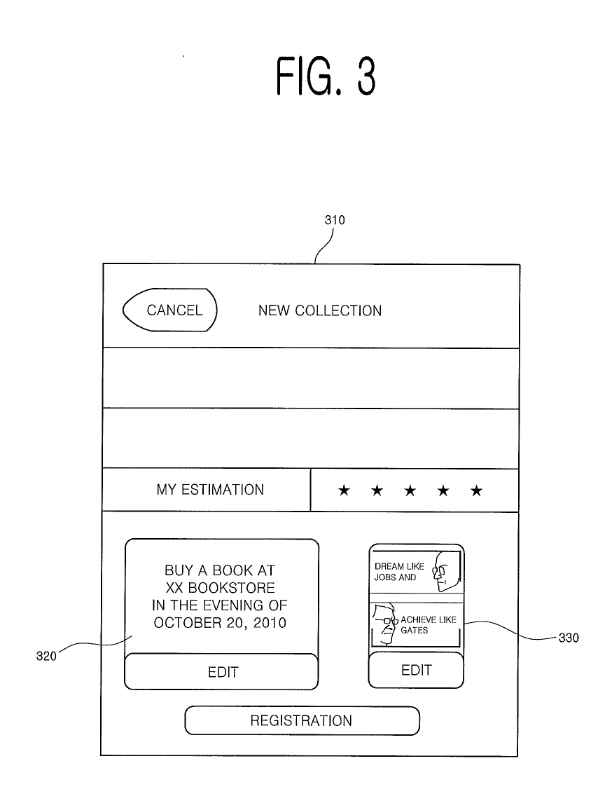

FIG. 3 illustrates an example of a collection page including information on an auto comment and an image of an object in accordance with an example embodiment of the present invention.

By referring to FIG. 3, it may be confirmed that the collection performing part 110 is creating a collection page 310 including an auto comment 320 which is grammatically combined in a user's language by using information on a place, i.e., “XX Bookstore,” where the image serving as the basic recognition information is created and a time, i.e., Oct. 20, 2010, when it is created, and a thumbnail 330 of the book. Herein, if a request for registering the collection page 310 is received, the collection performing part 110 may allow the collection page 310 of the user to be transmitted.

The collection performing part 110 in accordance with another example embodiment of the present invention may perform a function of acquiring and transmitting the basic recognition information with respect to the object which is a subject of the collection to the advertisement providing server 200 as well as recognizing the identity of the object which is the subject of the collection by comparing between the basic recognition information and the recognition reference information. A configuration of recognizing the identity of the object will be explained below in the part of “Configuration of Advertisement Providing Server”.

Next, the communication part 120 in accordance with an example embodiment of the present invention may perform a function of allowing the user terminal 100 to communicate with an external device.

Lastly, the control part 130 in accordance with an example embodiment of the present invention may perform a function of controlling data flow between the collection performing part 110 and the communication part 120. In short, the control part 130 may control the flow of data from outside or among the components of the user terminal 100 and thereby allow the collection performing part 110 and the communication part 120 to perform their unique functions.

### Configuration of Advertisement Providing Server

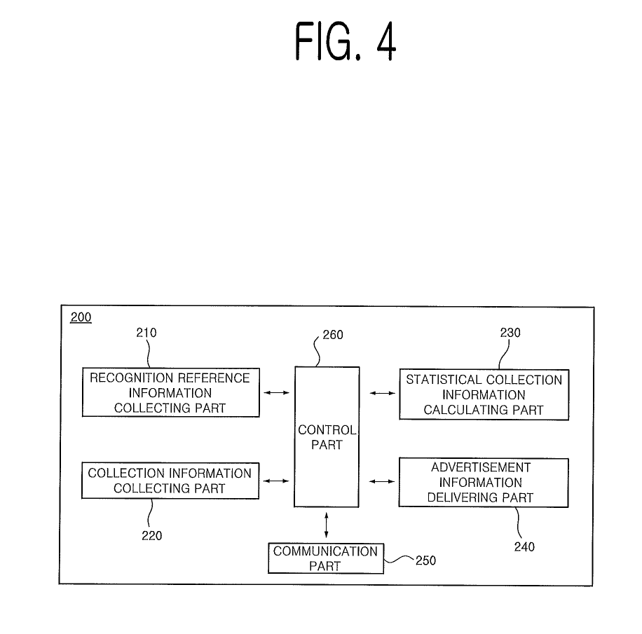

FIG. 4 exemplarily illustrates a configuration of the advertisement providing server 200 to provide advertising by using collection information in accordance with an example embodiment of the present invention.

As depicted in FIG. 4, the advertisement providing server 200 in accordance with an example embodiment of the present invention may include a recognition reference information collecting part 210, a collection information collecting part 220, the statistical collection information calculating part 230, an advertisement information delivering part 240, a communication part 250 and a control part 260. In accordance with an example embodiment of the present invention, at least some of the recognition reference information collecting part 210, the collection information collecting part 220, the statistical collection information calculating part 230, the advertisement information delivering part 240, the communication part 250 and the control part 260 may be program modules communicating with the advertisement providing server 200. The program modules may be included in the advertisement providing server 200 in a form of an operating system, an application program module and other program modules and may also be stored on several memory devices physically. Furthermore, the program modules may be stored on remote memory devices communicable to the advertisement providing server 200. The program modules may include but not be subject to a routine, a subroutine, a program, an object, a component, and a data structure for executing a specific operation or a type of specific abstract data that will be described in accordance with the present invention.

First, the recognition reference information collecting part 210 in accordance with an example embodiment of the present invention may perform a function of receiving, and then managing, the recognition reference information on an object sold or to be sold in connection with the vendor from the vendor server 300. As explained above, the recognition reference information may mean the information which is compared with the basic recognition information in order to recognize the identity of the object which corresponds to the basic recognition information actually acquired by the user terminal 100. For example, information on an image of an object taken and managed by the vendor, a name granted to the object by the vendor, other recognition codes, a barcode, a QR code, an RFID tag, an NFC tag, a location where the vendor places the object, etc. may fall under the recognition reference information. Such recognition reference information may be created and managed by the vendor who mainly produces and sells the object.

By collecting the recognition reference information of the object from the vendor server 300, a collection service provider may be able to acquire the recognition reference information on various objects easily and then use the acquired information to perform the object recognition and the collections, instead of spending efforts to create or manage the recognition reference information of the object. In order to easily acquire numerous data (i.e., the recognition reference information) the vendor possesses, the service provider, for reference, may allow the vendor to perform targeting advertising by providing the vendors, free of charge, with statistics calculated by the statistical collection information calculating part 230 to be explained later.

The recognition reference information collecting part 210 in accordance with another example embodiment of the present invention may transmit the recognition reference information collected from the vendor server 300 to the user terminal 100. In case of another example embodiment, it will be possible to allow the user terminal 100 to recognize the identity of the object as a subject of the collection in comparison between the basic recognition information and the recognition reference information.

Next, the collection information collecting part 220 in accordance with an example embodiment of the present invention may perform a function of collecting the collection information including the basic recognition information actually taken and created by using the user terminal 100 or the basic recognition information created as a result of acquisition through a short distance communication technology from the user terminal 100. Herein, the collection information may include the basic recognition information of the object which is a subject of the collection. If the user terminal 100 in accordance with another example embodiment of the present invention performs a further subsequent function of recognizing the object, creating the collection page, etc., the collection information may further include information on the identity of the object as the subject of the collection, a place where, and a time when, the basic recognition information of the object is acquired, a comment inputted by a user or automatically created during the course of the collection, pre-stored image corresponding to the object, etc.

The statistical collection information calculating part 230 in accordance with an example embodiment of the present invention may conduct a function of judging which object sold by the vendor the object falling under basic recognition information corresponds to, i.e., the object which is the subject of the collection, by comparing between the basic recognition information included in the collection information collected from the user terminal 100 and the recognition reference information acquired from the vendor server 300 to recognize the identity of the object.

On assumption that information on an image of an object, the name thereof, other recognition codes, a barcode, a QR code or the like is acquired as the basic recognition information, the statistical collection information calculating part 230 in accordance with an example embodiment of the present invention may carry out a function of recognizing the identity of the object by using an object recognition technology, a character recognition technology, a barcode recognition technology, etc.

As an object recognition technology for recognizing a peculiar object included in images with various angles and various distances, an article titled “A Comparison of Affine Region Detectors” authored jointly by K. MIKOLAJCZYK and seven others and published in “International Journal of Computer Vision” in November 2005 and the like, herein, may be referred to (The whole content of the article may be considered to have been combined herein). To recognize the respective objects shot at different angles as the same object more precisely, the aforementioned article describes how to detect an affine invariant region(s). Of course, the object recognition technology applicable to the present invention is not limited only to the method described in the article and it will be able to reproduce the present invention by applying various examples.

Moreover, an OCR technology for recognizing certain character strings included in the inputted image may refer to the specification of Korea Patent Application No. 2006-0078850, of which all must be considered to have been combined herein. The specification mentions a method for creating each candidate character forming a character string included in the inputted image and applying the character recognition technology to each created candidate character. The OCR technology which is applicable to the present invention is not limited to the method described in the specification but various examples may be applied.

In addition, a technology for recognizing a barcode included in the inputted image may refer to the specification of Korea Patent Registration No. 0791704, of which all must be considered to have been combined herein. The specification describes a method for extracting a barcode field by analyzing the adjacency relationship of connection fields on the basis of the characteristics of the structure of a barcode from the inputted image, determining a unit width which is to be used as a module width of the barcode in accordance with the width of the connection field of black pixel in the extracted barcode field and collating the barcode pattern defined as an arrangement of the magnification of the unit width with the input width pattern to recognize the barcode. The OCR technology which is applicable to the present invention is not limited to the method described in the specification but various examples may be assumed.

Suppose that RFID tag information, NFC tag information, etc. serving as the basic recognition information is acquired from the object by using the short distance communication technology, the statistical collection information calculating part 230 in accordance with an example embodiment of the present invention may perform a function of recognizing the identity of the object by using the short distance communication technology, etc. For the reason that the technology for recognizing the identity of the object itself corresponds to a well-known technology, the detailed explanation will be omitted herein. If the statistical collection information calculating part 230 recognizes the identity of the object by acquiring the basic recognition information, such as the RFID tag, the NFC tag or the like, from the object by using the short distance communication technology, it may be unnecessary to acquire an image by the collection performing part 110.

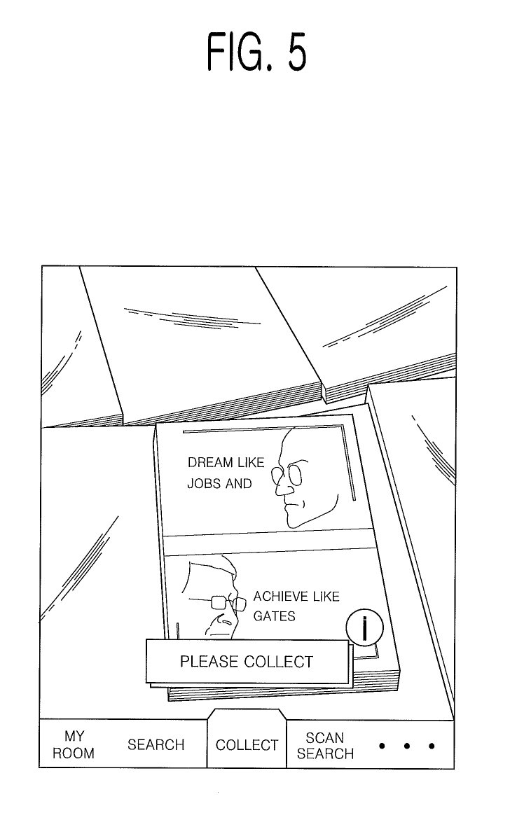

In accordance with an example embodiment of the present invention, FIG. 5 represents an example of recognizing the identity of the object by comparing the basic recognition information and the recognition reference information.

By referring to FIG. 5, if a book titled “Dream Like Jobs and Achieve Like Gates” is included in the collected image as the basic recognition information, the statistical collection information calculating part 230 may recognize the object included in the image as the book titled “Dream Like Jobs and Achieve Like Gates” by comparing the collected image with recognition reference information in a form of images or the like acquired from the vendor server 300 in use of technologies such as an objection recognition technology, a character recognition technology and/or a barcode recognition technology. If an NFC tag is collected as the basic recognition information, the statistical collection information calculating part 230 may recognize the object corresponding to the NFC tag as the book titled “Dream Like Jobs and Achieve Like Gates” by comparing the collected NFC tag with recognition reference information in a form of NFC tags or the like acquired from the vendor server 300.

The statistical collection information calculating part 230 in accordance with an example embodiment of the present invention may perform a function of calculating, and providing the vendor server 300 with, statistical information on a present state of users' collections based on information on users of the user terminals 100 who transmit collection information including the basic recognition information and information on an object(s), i.e., the object(s) which is a subject of the collection, recognized to correspond with the basic recognition information.

More precisely, the statistical collection information in accordance with an example embodiment of the present invention may include information on the number of collections of an object(s), a time(s) when, and a place(s) where, the object is collected, demographic information on the users on an anonymous basis, evaluation of the object(s) by users who collect the object(s), etc. and may be connected with the recognition reference information acquired from the vendor server 300. In accordance with the present invention, statistical collection information is not limited only to aforementioned information and any information which may give help in the improvement of an advertising effect of the vendor as information to be acquired during the course of collection or object recognition may be included in statistical collection information in the present invention.

The above is an explanation of the statistical collection information calculating part 230 performing functions of recognizing the object and calculating the statistics based on information on the recognized object, but the functions are not limited only thereto. Such functions may be performed separately by an object recognizing part (non-illustrated) and a statistic calculating part (non-illustrated).

If the vendor inputs information on selecting a peculiar object and a specific user group by referring to the statistical information provided to himself or itself and then the selected information is transmitted from the vendor server 300, the advertisement information delivering part 240 in accordance with an example embodiment of the present invention may carry out a function of transmitting certain advertisement information on the peculiar object to a user terminal(s) 100 included in the specific user group, where the advertisement information may include text advertising, image advertising, e-coupons and any other types of advertising. More specifically, the advertisement information may be made by the vendor and the advertisement information delivering part 240 may receive the advertisement information from the vendor server 300 and push the information to the user terminal(s) 100 of the specific user group.

In accordance with an example embodiment of the present invention, the advertisement information delivering part 240 may carry out a function of delivering the advertisement information only to the user terminal(s) 100 included in the specific group of the users which is determined by using a location where, and a time when, the collection is performed, i.e., the location where, and the time when, the basic recognition information is acquired, wherein the users in the specific group of the users perform a collection at a specific location or a particular time.

For instance, it may be assumed that the advertisement providing server 200 in the present invention acquires information on barcodes (or QR codes) as the recognition reference information on three objects, i.e., instant noodles A, B and C, from the server 300 of a large discount mart serving as the vendor and a user takes barcodes attached on the instant noodles A, B and C by using his or her terminal 100 to perform the collection. In accordance with an example embodiment of the present invention, if statistical collection information purporting that users who collect the noodle A are mainly 20-something men is calculated, the large discount mart may select to provide advertisement information on the instant noodle A only for terminal(s) 100 of the 20-something male users who have collected the instant noodle A or further for terminal(s) 100 of other 20-something male users, i.e., those who have not performed the collection of the instant noodle A by referring to the statistical collection information and if statistical collection information purporting that the instant noodle B is mainly collected near Dogok-dong Seoul is calculated, the large discount mart may select to provide advertisement information on the instant noodle B only for terminal(s) 100 of the users who have collected the instant noodle B near Dogok-dong or further for terminal(s) 100 of other users located near Dogok-dong, i.e., those who have not performed collections on the instant noodle B. If statistical collection information purporting that the instant noodle C is collected mainly during the time between 22:00 and 24:00 is calculated, the large discount mart may select to provide advertisement information on the instant noodle C only for terminal(s) 100 of the users who have collected the instant noodle C during the time between 22:00 and 24:00 or further for terminal(s) 100 of other users, who have not collected yet, during the time between 22:00 and 24:00.

Next, the communication part 250 in accordance with an example embodiment of the present invention may perform a function of allowing the advertisement providing server 200 in the present invention to communicate with external device.

Lastly, the control part 260 in accordance with an example embodiment of the present invention may perform a function of controlling the flow of data among the recognition reference information collecting part 210, the collection information collecting part 220, the statistical collection information calculating part 230, the advertisement information delivering part 240 and the communication part 250. In short, the control part 260 may control the flow of data from outside or among the components of the advertisement providing server 200 and thereby allow the recognition reference information collecting part 210, the collection information collecting part 220, the statistical collection information calculating part 230, the advertisement information delivering part 240 and the communication part 250 to perform their unique functions.

In accordance with the present invention, since the vendor may provide an advertisement which meets the collection tendency of the users and the system operator may easily acquire the recognition reference information required for recognizing the object, the vendor may maximize the advertising effect and the system operator may provide a function of more accurate recognition of the object which is the subject of the collection.

In accordance with the present invention, only if a user takes a certain object freely by using a user terminal or acquires information on the certain object through a short distance communication, it is possible to provide some incentives for the user with a result of accurate recognition based on numerous reference data easily secured by the system operator and to increase participation rates of the user by maximizing user satisfaction.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method for providing advertisement by using collection information, comprising the steps of:
(a) allowing recognition reference information on an object sold or to be sold in relation to a vendor from a vendor server to be received by a recognition reference information collecting part;
(b) allowing collection information, including digital data created by taking basic recognition information of the object with a user terminal or by acquiring the basic recognition information through a short distance communication, to be acquired by a collection information collecting part;
(c) allowing the object corresponding to the basic recognition information to be recognized by a statistical collection information calculating part by comparing between the basic recognition information included in the digital data in the collection information acquired from the user terminal and the recognition reference information received from the vendor server and allowing statistical collection information to be calculated by the statistical collection information calculating part by referring to the information on the recognized object and a user of the user terminal who remits the basic recognition information; and
(d) allowing advertising information on a peculiar object to be provided for a user terminal included in a specific user group by an advertising information delivering part, if the vendor inputs information on selecting the peculiar object and the specific user group by referring to the statistical collection information which is given to the vendor server;
wherein the collection is a process for acquiring the basic recognition information of the peculiar object the user intends to collect by using his or her user terminal and storing at least a piece of information on an identity of the peculiar object recognized by the acquired basic recognition information, a place where, and a time when, the basic recognition information thereof is acquired, a comment thereof and an image thereof; and
wherein the basic recognition information is recognition information which is a clue for recognizing the identity of the object and wherein the recognition reference information is recognition information to be compared with the basic recognition information to recognize the identity of the object.

2. The method of claim 1, wherein the recognition reference information includes at least a piece of information on an image of the object, a name thereof, other recognition codes, a barcode, a QR code, a tag for a short distance communication granted thereto, and a location where the object is placed.

3. The method of claim 1, wherein the digital data further includes at least a piece of (i) information on an auto comment including a grammatically combined phrase or sentence in the user's language by using at least a piece of information on the identity of the recognized object and a place where, and a time when, the basic recognition information is obtained and (ii) information on pre-stored image of the recognized object.

4. The method of claim 1, wherein the basic recognition information includes at least a piece of information on an image of the object taken by the user terminal, a name thereof, other recognition codes, a barcode, a QR code, a tag for a short distance communication granted thereto, and a location where the object is placed.

5. The method of claim 1, wherein the statistical collection information includes at least a piece of information on the number of collections of the object, a time when, and a place where, the object is collected, and demographic information on the users of terminals through which the collections of the object are performed on an anonymous basis.

6. The method of claim 1, wherein the advertising information includes information on a coupon issued by the vendor who serves or sells the object.

7. A server for providing advertisement by using collection information, comprising:
a recognition reference information collecting part for receiving recognition reference information on an object sold or to be sold in relation to a vendor from the vendor server;
a collection information collecting part for collecting collection information including digital data created by taking basic recognition information of the object with a user terminal or by acquiring the basic recognition information through a short distance communication;
a statistical collection information calculating part for recognizing the object corresponding to the basic recognition information by comparing between the basic recognition information included in the digital data in the collection information acquired from the user terminal and recognition reference information received from the vendor's server and calculating statistical collection information by referring to the information on the recognized object and a user of the user terminal who remits the basic recognition information; and
an advertising information delivering part for providing advertising information on a peculiar object for a user terminals included in a specific user group, if the vendor inputs information on selecting the peculiar object and the specific user group by referring to the statistical collection information which is given to the vendor server;
wherein the collection is a process for acquiring the basic recognition information of the peculiar object the user intends to collect by using his or her user terminal and storing at least a piece of information on an identity of the peculiar object recognized by the acquired basic recognition information, a place where, and a time when, the basic recognition information thereof is acquired, a comment thereof and an image thereof; and
wherein the basic recognition information is recognition information which is a clue for recognizing the identity of the object and wherein the recognition reference information is recognition information to be compared with the basic recognition information to recognize the identity of the object.

8. The server of claim 7, wherein the recognition reference information includes at least a piece of information on an image of the object, a name thereof, other recognition codes, a barcode, a QR code, a tag for a short distance communication granted thereto, and a location where the object is placed

9. The server of claim 7, wherein the digital data further includes at least a piece of (i) information on an auto comment including a grammatically combined phrase or sentence in the user's language by using at least a piece of information on the identity of the recognized object and a place where, and a time when, the basic recognition information is obtained and (ii) information on pre-stored image of the recognized object.

10. The server of claim 7, wherein the basic recognition information includes at least a piece of information on an image of the object taken by the user terminal, a name thereof, other recognition codes, a barcode, a QR code, a tag for a short distance communication granted thereto, and a location where the object is placed.

11. The server of claim 7, wherein the statistical collection information includes at least a piece of information on the number of collections of the object, a time when, and a place where, the object is collected, and demographic information on the users of terminals through which the collections of the object are performed on an anonymous basis.

12. The server of claim 7, wherein the advertising information includes information on a coupon issued by the vendor who serves or sells the object.

13. One or more computer-readable recording media having stored thereon a computer program that, when executed by one or more processors, causes the one or more processors to perform acts including:
allowing recognition reference information on an object sold or to be sold in relation to a vendor from a vendor server to be received by a recognition reference information collecting part;
allowing collection information, including digital data created by taking basic recognition information of the object with a user terminal or by acquiring the basic recognition information through a short distance communication, to be acquired by a collection information collecting part;
allowing the object corresponding to the basic recognition information to be recognized by a statistical collection information calculating part by comparing between the basic recognition information included in the digital data in the collection information acquired from the user terminal and the recognition reference information received from the vendor server and allowing statistical collection information to be calculated by the statistical collection information calculating part by referring to the information on the recognized object and a user of the user terminal who remits the basic recognition information; and
allowing advertising information on a peculiar object to be provided for a user terminal(s) included in a specific user group by an advertising information delivering part, if the vendor inputs information on selecting the peculiar object and the specific user group by referring to the statistical collection information which is given to the vendor server;
wherein the collection is a process for acquiring the basic recognition information of the peculiar object the user intends to collect by using his or her user terminal and storing at least a piece of information on an identity of the peculiar object recognized by the acquired basic recognition information, a place where, and a time when, the basic recognition information thereof is acquired, a comment thereof and an image thereof; and
wherein the basic recognition information is recognition information which is a clue for recognizing the identity of the object and wherein the recognition reference information is recognition information to be compared with the basic recognition information to recognize the identity of the object.
